(19) United States
(12) Patent Application Publication
(10) Pub. No.: US 2007/0062914 A1
(43) Pub. Date: Mar. 22, 2007

(54) Resistance welding-use electrode

(76) Inventors: Motoki Saji, Osaka (JP); Mitsutoshi Kamakura, Osaka (JP); Masaya Nakai, Osaka (JP)

Correspondence Address: FISH & RICHARDSON P.C., P.O. BOX 1022, MINNEAPOLIS, MN, 55440-1022, US

(21) Appl. No.: 11/524,233

(22) Filed: Sep. 19, 2006

(30) Foreign Application Priority Data
Sep. 20, 2005 (JP) 2005-271534

(51) Int. Cl. B23K 11/30

(52) U.S. Cl. 219/119

(57) ABSTRACT

In a conventional resistance welding-use electrode, a foot portion at the end is divided into three segments. An object such as a cap is inserted into a hole at the end. The foot portion is bent inward to hold the object by a force, and the object (cap) is pressed to a stem. Under this condition, a current is fed to perform resistance welding. A gap remains between the individual segments of the foot portion. Therefore, the current density is uneven, producing unevenness in the welding. A soft object may deform. The electrode wears and deforms due to repeated use, reducing its useful life. Because of the existence of the gap, pressing marks are sometimes formed in the welded portion. In the present invention, a permanent magnet is embedded at the end portion of the electrode to hold the object by magnetic force of the permanent magnet. Even when the foot portion at the end portion is closed, the inner diameter of the hole produced by the surrounding foot portion is designed to be larger than the outer diameter of the object, so that the pressing force is not applied to the object.

### BACKGROUND OF THE INVENTION

1. Field of the Invention

The present invention relates to a resistance welding-use electrode that performs the welding by injecting a current in a state in which a cap is pressed to a stem which holds the cap and to which a semiconductor device is attached. For example, when a bottom of a cylindrical cap having an attached lens is bonded to a stem having an attached semiconductor laser, the resistance welding or the YAG (yttrium aluminum garnet) laser welding is used. When a cap having a lens is fixed to a stem having an attached light-receiving device, also, the resistance welding or the YAG welding is used. In addition, in the case of an electric device having no lens, also, when a cap is bonded to a stem, a welding method is used. In the YAG welding, a laser beam is applied to a portion where a flange portion at the bottom of a cap is placed on top of a stem to heat and melt them, so that the cap and the stem are welded. In the resistance welding, while a cap and a stem are being held in contact with each other, a current is fed across them, so that they are heated due to the resistance at the contacting portion between them. The heat melts part of them, and then the melted portions are cooled and solidified. Thus, they are tightly bonded.

A resistance welding-use electrode is a jig to be used to hold a cap by making contact with the outside of the cap, to press the cap onto a stem, and to feed a current across the cap and the stem. The electrode has a cylindrical shape and holds the cap in a hole at the bottom end portion. While holding the cap, the electrode carries it onto the stem on a stage. A flange portion at the bottom end of the cap is brought into contact with the stem to feed a current instantaneously, so that the contacting portion is melted and the two components are bonded. The inner wall of the electrode must make tight contact with the cap. Consequently, the foot portion at the lower portion of the electrode has a structure in which the foot portion is divided into three or four segments, for example, to facilitate the insertion of the cap into the hole. When the foot portion is clamped, the foot portion is bent inward to strongly clamp the outer wall of the cap. It is necessary to press the foot portion inward until the gap between the outer wall of the cap and the inner wall of the electrode disappears. Therefore, the structure is designed such that even under the clamped condition, a gap remains between the individual segments of the foot portion.

2. Description of the Background Art

Patent literature 1 relates to a resistance welding apparatus that welds a cap and a stem after high-precision positioning is performed. This apparatus has an upper electrode-moving platform that holds an upper electrode holder and moves up and down. The platform has a coil spring. The coil spring becomes fatigued and lowers its position gradually. To prevent this, Patent literature 1 has provided the upper electrode-moving platform with a movement-restricting component. This is not an invention of a resistance welding-use electrode itself. As far as the present inventors examined, the present inventors were not able to find a literature on the shape of the resistance welding-use electrode.
Patent literature 1: the published Japanese patent application Tokukai 2003-154463 entitled “resistance welding apparatus.”

FIG. 1 is a cross-sectional view for explaining the structure of a holding portion of a resistance welding-use electrode according to a conventional example. An optical device (laser diode, photodiode, light-emitting diode, or the like) is already attached to a stem 2 having the shape of a circular disk. Lead pins and the optical device are connected with each other by wire bonding. An object of this apparatus is to weld a cap 3 having a lens to the disk-shaped stem 2. A resistance welding-use electrode 4 holds the cap. The bottom-end portion of the resistance welding-use electrode 4 is a foot portion 7 that is divided into three segments each having a center angel of about 120 degrees. The diameter I of the inner wall of the foot portion 7 at a free state is larger than the outer diameter D of the cap. A gap 8 exists between the individual segments of the foot portion 7. The gap 8 has two stages. The gap 8 shown in FIG. 1 is a narrower one. The magnitude of the gap is denoted as “s.” The arc length of the inner wall of each of the three segments of the foot portion 7 is denoted as “q.” The inner circumferential length at a free state is L=3q+3s. When the foot portion is pressed from the outside, the gaps disappear and the inner circumferential length becomes M=3q.

The outer circumferential length of the upper cylindrical portion of the cap 3 is denoted as K. In order for the upper cylindrical portion of the cap to easily slide into the foot portion, which is divided into three segments, of the resistance welding-use electrode, the condition is L>K. The foot portion 7 slides onto the outer periphery of the cap 3, and a clamping member presses the outside of the foot portion 7. Then, the foot portion bends inward to reduce the gap. As a result, the inner circumferential length of the foot portion becomes equal to the outer circumferential length K of the cap. Under this condition, the magnitude of the gap 8 is denoted as “t.” Consequently, 3q+3t=K (s>t). In other words, a finite gap “t” (t>0) exists. In this case, if the finite gap “t” does not exist, the cap can slide out from the foot portion. Therefore, L>K>M. The outer circumferential length K of the cap exists in the range of the change in the inner circumferential length of the foot portion from the free state to the clamped state.

A stage 5 for supporting the stem 2 is provided at a lower position. The stem 2 is placed in a recessed portion 6 of the stage 5. The cap 3 is securely held by the foot portion at the end of the resistance welding-use electrode 4 to be carried such that a flange 20 at the bottom end of the cap is brought into contact with the upper face of the stem 2. Then, after the cap is aligned to determine the position, the welding is performed.

FIG. 2 is a cross-sectional view showing a state in which the cap 3 is pressed on the stem 2. The outer wall of the cylindrical portion of the cap 3 is brought into contact without a gap with the inner wall of a foot portion 7 of a resistance welding-use electrode 4. The finite gap “t” remains. The foot portion 7 of the electrode applies a stress to the cap in a direction toward the center. The stress prevents the cap from sliding out from the hole of the electrode.

FIG. 3 is a perspective view of an end portion of a conventional resistance welding-use electrode 4 showing a state in which the cylindrical portion of the cap 3 is held by the foot portion 7 of the electrode 4.

FIG. 4 is a cross-sectional view of a front-end portion when the clamping is performed. Even when a foot portion 7 is closed, because the outer diameter of the cap is large, the gaps 8 remain. As shown in FIG. 4, the outer side of the foot portion 7 is pressed by a cylindrical clamping member 9, so that the foot portion 7 bends inward. The outer periphery of the cap 3 and the inner surface of the foot portion 7 of the resistance welding-use electrode 4 are brought into tight contact with each other. The gap 8 exists between the individual segments of the foot portion 7 divided into three segments. If the gap 8 does not exist under the closed condition, the foot portion 7 cannot hold the cap 3 (the object to be held). The gap 8 (the gap length is decreased to “t”) at the time of the closing condition is essential for the conventional resistance welding-use electrode.

In the conventional resistance welding-use electrode 4, the foot portion 7 itself of the electrode is bent inward to apply force to the cap so that the frictional force can hold the cap. Therefore, the gap 8 remains under the clamped condition. Contacting portions and non-contacting portions (the portions of the gap) are produced between the foot portion 7 of the electrode 4 and the combination of the cap and stem.

FIG. 5 is a partially cross-sectional plan view showing a state in which the foot portion 7 of the conventional resistance welding-use electrode 4 holds the cap 3 and presses it to the upper face of the stem 2. The foot portion 7 of the resistance welding-use electrode presses the upper face of a flange 20 of the cap 3 to feed a current vertically in that state.

The portions marked with oblique broken lines are contacting portions Q, through which the current flows from the foot portion 7 to the flange 20 to the stem 2. The current heats those portions to melt them. Then, they are cooled and solidified to be bonded. However, the current does not flow the non-contacting portions S (gap portions) shown without the oblique broken lines. As a result, those portions in the flange 20 of the cap are not heated sufficiently. The temperature becomes lower in the non-contacting portions S. Consequently, the welding cannot be performed uniformly over the entire circumference of the cap. The welding becomes uneven such that the contacting portions Q are welded and the non-contacting portions S are insufficiently welded. Even the electrode suffers irregular wearing. The same electrode is used repeatedly. As a result, uneven welding increases as the number of times of the use increases, which is not desirable. It is desirable that the current flow uniformly over the entire circumference to heat uniformly so that uniform welding can be performed.

The resistance welding-use electrode is pushed down strongly to press the cap and stem onto the stage. However, because of the existence of the gap, pressing marks are formed by the rising of the gap portions and remain on the cap. This is also undesirable. Another drawback in this structure is that because the foot portion itself of the electrode is bent inward to hold the cap, the object to be held (the cap, for example) may be distorted. As can be seen from FIGS. 4 and 5, the outer wall of the object (the cap) 3 is strongly pressed by the foot portion 7. In the case where the object is made of thin metal, the object may deform. If the object is deformed, it becomes an unsatisfactory product. In the case where the cap has a lens, when the pressing force is strong, the lens may break. It is not desirable to hold a considerably soft object by the clamping method. It is desirable to employ a structure in which the object can be held without applying intense stress.

The fact that an intense stress is applied to the object means that the same intense stress is applied to the electrode itself. Because such an intense stress is applied repeatedly, the foot portion of the resistance welding-use electrode is gradually deformed. Even when the resistance welding-use electrode is deformed or wears, it can be used by polishing again. Even when used by repeated polishing, the conventional resistance welding-use electrode can be used only 1,000 shots or so, because it suffers considerable deformation and wearing due to nonuniform current and intense stress.

### SUMMARY OF THE INVENTION

An object of the present invention is to offer a resistance welding-use electrode that does not produce nonuniformity in welding. Another object of the present invention is to offer a resistance welding-use electrode that has no possibility of deforming or damaging the object to be weld. Yet another object is to offer a resistance welding-use electrode that has a long useful life allowing repeated use over and over again.

### MEANS TO SOLVE THE PROBLEM

A resistance welding-use electrode of the present invention is designed such that even when the electrode is clamped and closed, the inner diameter of the cylindrical portion is larger than the outer diameter of the object to be welded. In addition, the electrode is provided with a permanent magnet so that the object can be held by magnetic force of the permanent magnet.

The object (cap) is held not by pressing it but by magnetic force of the permanent magnet. Therefore, it is essential that the cap be a ferromagnetic body, such as iron. Kovar is used for the cap in many cases. Kovar contains iron, nickel, and the like and is magnetized by a permanent magnet to be attracted to it. The present invention cannot be applied to a nonmagnetic object.

When the foot portion is closed, the inner circumferential length is 3q. Therefore, the fact that the inner circumferential length is larger than the outer circumferential length K of the cap means 3q>K. It is important that when the foot portion is closed by the clamping, the gap disappear. Because no gap exists, the current flows without unevenness. The current flows uniformly over the entire circumference of the flange. When the current flows uniformly, the amount of heat generation becomes uniform. The state of heating and melting also becomes uniform over the entire circumference. As a result, the state of the welding becomes uniform circumferentially. No unevenness in the welding is produced.

To achieve the above-described result, it is necessary to slightly increase the circumferential length of the foot portion, which is divided into segments, over the conventional example. In the present invention, the gap length at a free state is denoted as “s,” and the inner arc length of each segment is denoted as “q.” Then, the inner circumferential length of the foot portion at a free state is L=3q+3s. Its inner circumferential length at the clamped state is M=3q. The outer circumferential length K of the cap is smaller than that. In other words, not L>K>M (conventional example), but L>M>K.

Consequently, (M−K) becomes positive. In other words, when the foot portion is clamped, a gap having a value of (M−K)/π is produced between the cap and the foot portion. Because a finite gap exists, the object (cap) is not pressed. A stress is not applied to the cap. Therefore, the object has no possibility of deforming. No matter how soft the object (cap) is, it can be held. The fact that the object does not deform means that the resistance welding-use electrode itself is free form an external force and does not deform. As a result, the useful life of the resistance welding-use electrode itself is prolonged.

### EFFECT OF THE INVENTION

The present invention offers a resistance welding-use electrode that holds an object by magnetic force of a permanent magnet and that can produce a gap between the foot portion and the object even when the foot portion is closed. The foot portion does not press the object, so that a strong force is not applied to the object. Consequently, the object has no possibility of deforming. Any object can be held. Because the resistance welding-use electrode itself is free form high stress, it does not deform. On the other hand, at the time the foot portion is closed, no gap exists at a foot portion's end face that makes contact with the flange. Therefore, no pressing marks are formed.

Because no gap exists at a foot portion's end face that makes contact with the flange, a current flows uniformly and the heating condition becomes uniform over the entire periphery of the cap. Therefore, the welding becomes uniform over the entire periphery. No unevenness in the welding is produced. The uniform welding renders the sealing perfect.

A conventional electrode secures the positional precision by clamping. However, the existence of the gap portion shortens the useful life of the electrode. On the other hand, in the present invention, although the positional precision varies due to the large hole diameter, the position of the cap in the hole of the electrode is uniquely determined by the magnetic holding. As a result, a positional precision comparable to the clamping method can be secured.

Because the resistance welding-use electrode itself does not undergo an external force, it does not deform. Consequently, it can be used repeatedly over and over again. In other words, it can be a long-life resistance welding-use electrode. On the other hand, a conventional resistance welding-use electrode has an average life of no more than 1,000 shots or so even when polished repeatedly. In contrast, an electrode of the present invention can be used 3,000 shots or more through polishing and reforming.

Even when a resistance welding-use electrode of the present invention becomes fatigued by the use, the permanent magnet can be removed to attach it to another jig. Although a powerful permanent magnet is high-cost, the repeated use of it prevents a substantial increase in cost.

### BRIEF DESCRIPTION OF THE DRAWING

FIG. 1 is a disassembled cross-sectional view vertically showing part of a conventional resistance welding-use electrode, a cap of a device, a stem, and a stage of a welding apparatus.

FIG. 2 is a cross-sectional view showing a state in which a conventional resistance welding-use electrode, a cap of a device, a stem, and a stage of a welding apparatus are vertically assembled such that the resistance welding-use electrode presses a flange of the cap and the stem onto the stage.

FIG. 3 is a perspective view showing a state in which a cap is held by inserting the cap into a hole at the end of a conventional resistance welding-use electrode and by pressing a foot portion to the cap.

FIG. 4 is a cross-sectional view showing a state in which a cap is held by inserting the cap into a hole at the end of a conventional resistance welding-use electrode and by pressing a foot portion to the cap.

FIG. 5 is a cross-sectional view showing the presence of contacting portions and non-contacting portions between a foot portion and a flange of a cap in a state in which the cap is held by inserting the cap into a hole at the end of a conventional resistance welding-use electrode and by pressing the foot portion to the cap.

FIG. 6 is a front view showing the resistance welding-use electrode in Example 1 of the present invention.

FIG. 7 is a bottom view showing the resistance welding-use electrode in Example 1 of the present invention.

FIG. 8 is a diagram showing an 8-8 cross section in FIG. 6.

FIG. 9 is a diagram showing a 9-9 cross section in FIG. 8.

FIG. 10 is a diagram showing a 10-10 cross section in FIG. 8.

FIG. 11 is a perspective view showing a state in which a cap is held by the resistance welding-use electrode in Example 1 of the present invention.

FIG. 12 is a disintegrated cross section vertically showing a state in which a cap of a device is held by the resistance welding-use electrode in Example 1 of the present invention, and a stem is inserted into a hole of a stage of a welding apparatus.

FIG. 13 is a cross-sectional view vertically showing a state in which a cap of a device is held using magnetic force by the resistance welding-use electrode in Example 1 of the present invention, and the cap is pressed onto a stem inserted into a hole of a stage, so that the cap is brought into contact with the stem.

FIG. 14 is a partially cross-sectional plan view for showing the contacting portions of a foot portion, a flange, and a stem in a state in which a cap of a device is held using magnetic force by the resistance welding-use electrode in Example 1 of the present invention and the cap is pressed onto the stem inserted into a hole of a stage, so that the cap is brought into contact with the stem.

FIG. 15 is a vertical cross section showing the resistance welding-use electrode in Example 2 of the present invention.

FIG. 16 is a diagram showing a 16-16 cross section in FIG. 15.

FIG. 17 is a diagram showing a 17-17 cross section in FIG. 15.

FIG. 18 is a perspective view showing the resistance welding-use electrode in Example 2 of the present invention in a free state and the cap.

FIG. 19 is a cross-sectional view showing a state in which a cap is inserted into a hole at the end of the resistance welding-use electrode in Example 2 and the cap is held by magnetic force.

FIG. 20 is a perspective view showing a state in which a cap is held by the resistance welding-use electrode in Example 2 of the present invention.

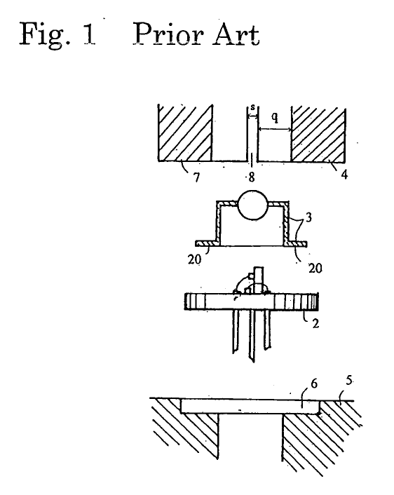

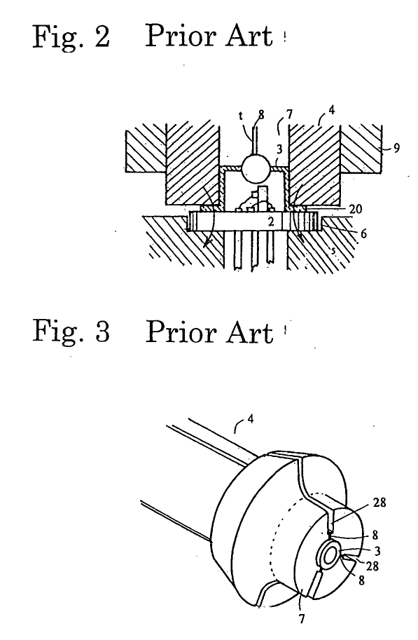

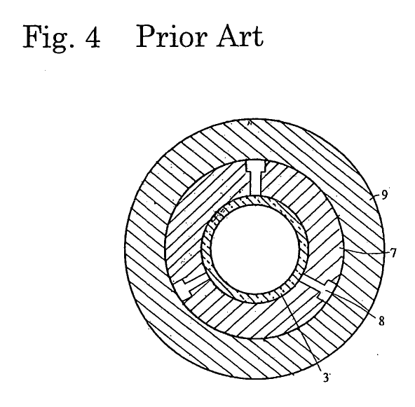

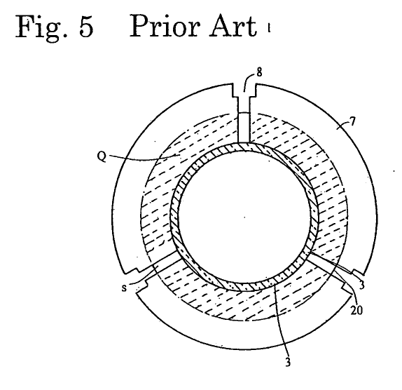

### EXPLANATION OF THE SIGN

2: stem; 3: cap; 4: resistance welding-use electrode; 5: stage; 6: recessed portion; 7: foot portion; 8: gap; 9: clamping member; 20: flange; 22: divided barrel portion; 23: head portion; 24; neck portion; 25: foot-portion hole; 26: end face; 27: circular conical portion; 28: gap; 29: pressing piece; 30: magnet-housing hole; 32: permanent magnet; 33: screw; 35: magnet-housing hole; 36: screw; 38: boundary line; 39: gap.

### DETAILED DESCRIPTION OF THE INVENTION

A resistance welding-use electrode of the present invention is a nonmagnetic body. It is made of copper or copper alloy, which has high electric conductivity. The cap is held by magnetic force of a permanent magnet. Consequently, it must be a magnetic body made of iron, cobalt, nickel, or the like. A cap containing iron can be held with a permanent magnet, so that the present invention can be applied to it. Here, a cap made of Kovar (a brand name) is used. It is composed of 29% nickel, 17% cobalt, and 54% iron. The density is 8.35 g/cm³. The melting point is 1,450° C. The electric resistivity at 20° C. is 0.49μ Ω·m. The thermal conductivity is 16.7 W/mK. The magnetic transformation point is 430° C. The hardness is 155 Hv. The tensile strength is 540 N/mm². The example shown here is used as an optical device, so that it has a lens. However, the present invention can also be applied to a nonoptical device. In that case, no lens is used.

### Example 1

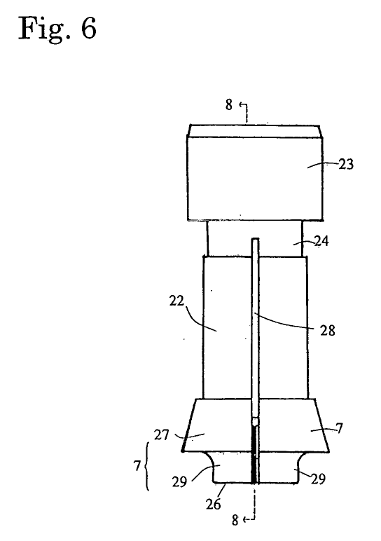

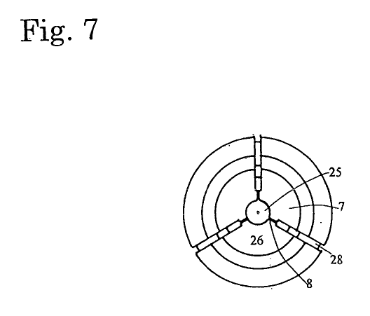

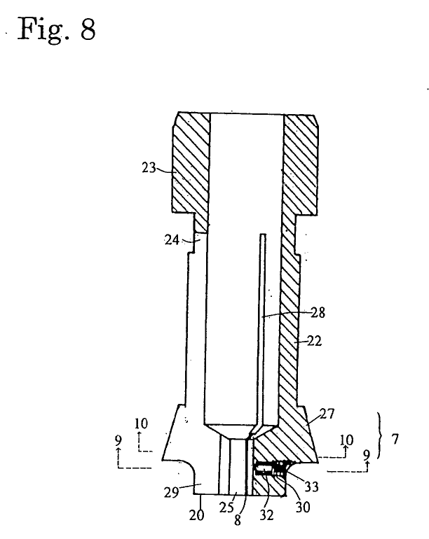

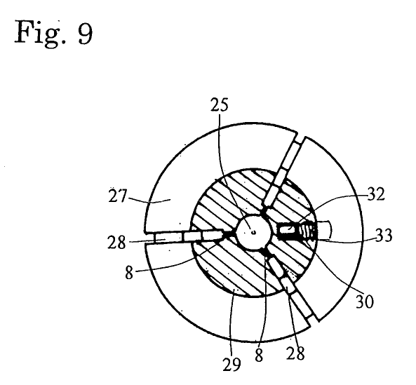

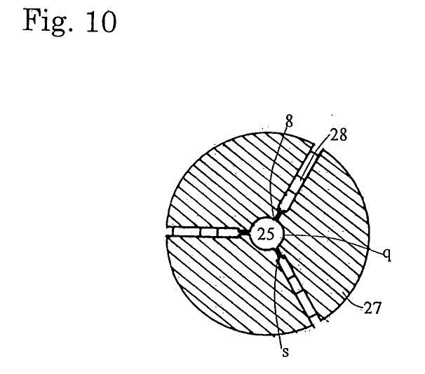

FIG. 6 is a front view showing a resistance welding-use electrode in Example 1 of the present invention. FIG. 7 is a bottom view. FIG. 8 is a diagram showing an 8-8 cross section in FIG. 6. FIG. 9 is a diagram showing a 9-9 cross section in FIG. 8. FIG. 10 is a diagram showing a 10-10 cross section in FIG. 8. A resistance welding-use electrode of the present invention is a cylindrical jig. It comprises, from above, a head portion 23, a neck portion 24, a barrel portion 22 divided into three segments, and a foot portion 7 directly following the barrel portion 22. The foot portion 7 has an end face 26 provided with a foot-portion hole 25 for holding an object. The foot portion 7 is divided into three segments, and a gap 28 exists between the individual segments.

The gap 28 is directly connected to a gap 8 at the end portion. The gap 28 is larger than the gap 8 at the end portion. The reason why the lower half of the resistance welding-use electrode is divided into three segments is that it is necessary to bend the foot portion 7. The number of segments is not limited to three; four or five may be employed. The gap 28 extends to some mid position of the neck portion 24. The upper half of the foot portion 7 forms a circular conical portion 27, which increases its diameter as the position moves downward. The lower half of it forms a pressing piece 29, whose diameter is reduced. Such a structure is nearly the same as that shown in the conventional example.

As shown in the vertical cross section in FIG. 8 and in the cross section in FIG. 9, a magnet-housing hole 30 is provided radially in the pressing piece 29, which is close to the end face 26 and has a reduced diameter. The magnet-housing hole 30's half portion close to the entrance forms a female screw hole. The magnet-housing hole 30 houses a permanent magnet 32. A screw 33 is screwed into the female screw hole to prevent the permanent magnet 32 from coming off. As the permanent magnet 32, a powerful magnet made of, for example, samarium cobalt is used. Here, the magnet-housing hole has an inner diameter of 2.1 mm. A columnar permanent magnet having a length of 1.9 mm and a diameter of 1.9 mm is screwed into the magnet-housing hole 30. The distance between the wall surface of a hole 25 into which the object (cap) is inserted and the end face of the permanent magnet 32 is about 1 mm.

At a free state, the gaps 8 exist and the inner circumferential length L of the hole is the sum of the three gaps, 3s, and the three inner arc lengths, 3q, of the three segments of the foot portion 7; that is, L=3s+3q. When the foot portion 7 is pressed inward with a clamping member, the gaps 8 disappear completely. The neighboring segments of the foot portion 7 are brought into tight contact with one another. The inner circumferential length of the hole 25 becomes M=3q. At this moment, this structure is designed such that a gap remains between the cap as the object and the wall of the hole 25. More specifically, when the outer circumferential length of the cap is denoted as K, then M=3q>K. In the conventional example, the relationship is L>K>M. On the other hand, in the present invention, the relationship is changed to L>M>K.

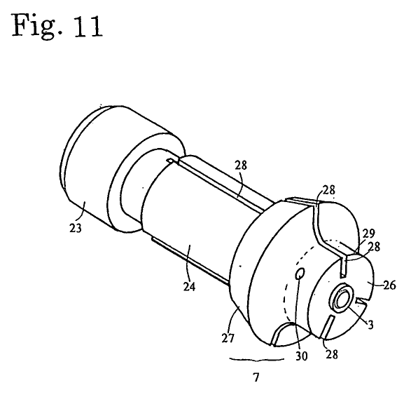

At the time of the closing, the gaps 8 are closed and disappear. FIG. 11 is a perspective view showing such a state. Actually, a clamping member is provided for pressing the circular conical portion 27 of the foot portion 7. However, this member is omitted from FIG. 11. The cap 3 is held in the hole at the center of the end face 26. Because the gap 8 between the individual segments of the foot portion 7 has disappeared, the end face 26 becomes a flat face at an area lying over the flange of the cap without having something like a groove. The disappearance of the gap 8 is clearly seen by comparing FIG. 11 with FIG. 3, which is a perspective view showing the conventional example.

The cap 3 is held not by mechanical stress but by magnetic force of the permanent magnet 32. The cap 3 is made of a material that can be attracted by a magnet, such as iron, cobalt, or nickel.

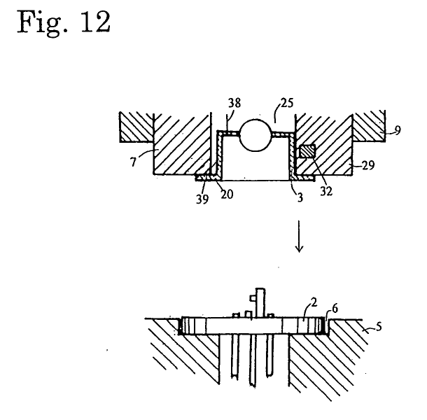

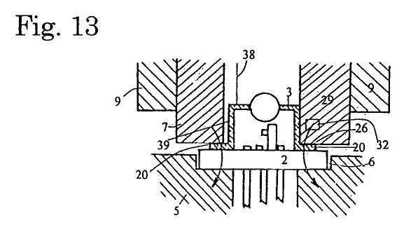

FIGS. 12 and 13 explain a state in which the cap 3 is held by the resistance welding-use electrode 4, and the cap 3 is combined with the stem 2. Under the condition that the foot portion 7 is opened, the resistance welding-use electrode is slid over the cap. A clamping member 9 presses the foot portion 7 to close it. The upper diagram in FIG. 12 shows this state. The three segments are brought into contact with one another. The gap 8 disappears, leaving a boundary line 38. No gap 8 exists, but only the boundary line 38 remains.

The cap 3 is loosely fitted into the hole 25. A gap 39 exists between the cap 3 and the wall of the hole 25. The cap 3 is held in the hole 25 by the force of the permanent magnet 32. Because the gap 39 remains, no inward force is applied to the cap 3. Therefore, the cap has no possibility of deforming. The wall of the hole 25 made by the foot portion of the resistance welding-use electrode, also, has no possibility of deforming or wearing. Furthermore, the wall that forms the gap 8's edge portion close to the hole 25 also has no possibility of deforming or wearing. Although the gap 39 is shown in exaggeration, actually, it is a tiny gap. The value obtained by dividing the difference between the outer circumferential length of the cap, K, and the inner circumferential length of the hole 25 at the time of the closing, M=3q, by π, that is, (M−K)/π, shows the diametrical magnitude of the gap 39. As shown in the lower diagram in FIG. 12, the stem 2 is inserted into the recessed portion 6 of the stage 5.

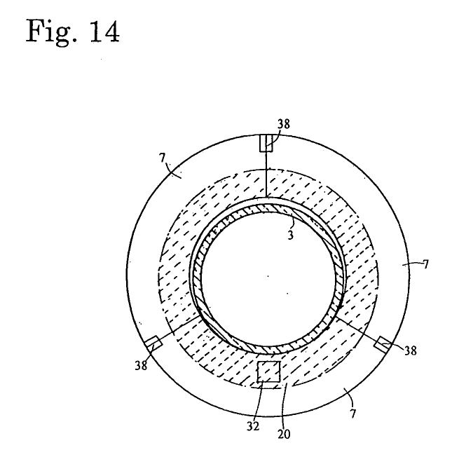

When the resistance welding-use electrode and the cap are lowered to put on top of the stem 2, a state shown in FIG. 13 is produced. The bottom flange 20 of the cap 3 is brought into contact with the upper face of the stem 2. The foot portion 7 of the resistance welding-use electrode 4 presses the flange 20 intensely. FIG. 14 is a partially cross-sectional plan view showing the contacting portions when viewed down from the resistance welding-use electrode. The three segments of the foot portion 7 are brought into tight contact with one another without a gap at the boundary lines 38. Consequently, the lower portion of the resistance welding-use electrode 4 at a portion lying over the flange 20 is circumferentially unified. The unified foot portion 7 presses the flange 20 onto the stem 2.

Because the foot portion 7 has no gaps at a portion lying over the flange 20, when an electric current is injected into the resistance welding-use electrode vertically, the current flows uniformly over the entire circumference of the flange. The end face of the electrode, the flange of the cap, the stem, and the stage are placed on top of each other in this order. At this moment, no gap exists circumferentially at all. When a heavy current is fed across the resistance welding-use electrode and the stage, the current flows vertically with maintaining a uniform current density circumferentially in the flange. Although the gap 39 exists between the wall of the hole 25 of the resistance welding-use electrode and the cap 3, the gap does not affect the current density. The current does not flow from the inner face of the pressing piece 29 of the foot portion 7 to the outer face of the cap. Instead, the current flows from the end face 26 of the foot portion 7 to the flange 20, to the stem 2, and to the recessed portion 6. Therefore, the existence of the gap 39 does not create any problem. What is more important is that the end face is unified without gaps so as to press the flange 20 without gaps.

Because the current density is uniform circumferentially, the heating becomes uniform circumferentially. The state of the welding also becomes uniform circumferentially. The welding has no possibility of producing unevenness. As shown in FIGS. 12 and 13, the cap is held by magnetic force of the permanent magnet. Consequently, a force is not applied to the outer periphery of the cap. Because the cap is free from stress, it has no possibility of deforming, distorting, or the like. Because the resistance welding-use electrode also does not undergo an external force, it does not deform or wear. The useful life of the electrode is prolonged. The conventional electrode has a useful life of no more than 1,000 shots or so even when used by repeated polishing. On the other hand, the electrode in Example 1 of the present invention has a useful life of 3,000 shots or more.

### Example 2

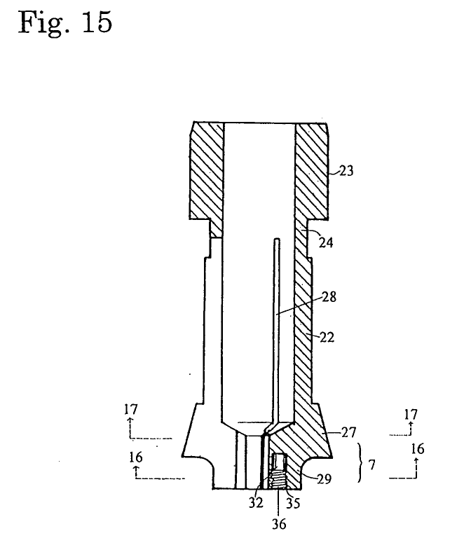

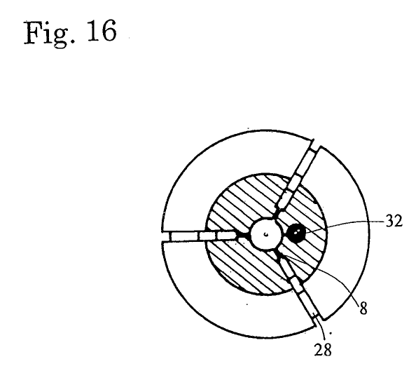

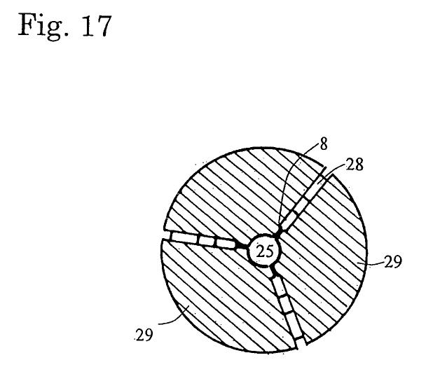

In the electrode in Example 1, the permanent magnet is housed in a hole bored radially. In contrast, in the electrode in Example 2, the permanent magnet is housed in a hole bored axially. Except that feature, the electrode in Example 2 has the same structure as that of the electrode in Example 1. FIG. 15 is a vertical cross section showing the resistance welding-use electrode in Example 2 of the present invention. FIG. 16 is a diagram showing a 16-16 cross section in FIG. 15. FIG. 17 is a diagram showing a 17-17 cross section in FIG. 15. A front view and a bottom view are omitted because they are nearly the same as those in FIGS. 6 and 7.

A resistance welding-use electrode in Example 2 is a cylindrical jig. It comprises, from above, a head portion 23, a neck portion 24, a barrel portion 22 divided into three segments, and a foot portion 7 directly following the barrel portion 22. The foot portion 7 has an end face 26 provided with a foot-portion hole 25 for holding an object. The foot portion 7 is divided into three segments, and a gap 28 is provided between the individual segments.

The gap 28 is directly connected to a gap 8 at the end portion. The gap 28 is larger than the gap 8 at the end portion. The lower half of the resistance welding-use electrode is divided into three segments. The number of segments is not limited to three; four or five may be employed. The gap 28 extends to some mid position of the neck portion 24. The upper half of the foot portion 7 forms a circular conical portion 27, which increases its diameter as the position moves downward. The lower half of it forms a pressing piece 29, whose diameter is reduced. Such a structure is nearly the same as that in Example 1.

A magnet-housing hole 35 is provided axially from the end face 26 in the pressing piece 29 of the resistance welding-use electrode 4. The magnet-housing hole 35's half portion close to the entrance forms a female screw hole. The magnet-housing hole 35 parallel to the axis houses a permanent magnet 32. A screw 36 is screwed into the female screw hole to prevent the permanent magnet 32 from coming off. As the permanent magnet 32, a powerful magnet made of, for example, samarium cobalt is used. Here, the magnet-housing hole 35 provided axially has an inner diameter of 2.1 mm. A columnar permanent magnet 32 having a length of 1.9 mm and a diameter of 1.9 mm is screwed into the magnet-housing hole 35. The axis of the permanent magnet 32 is parallel to the axis of the cap. The direction of the magnetization of the permanent magnet may either be axial or diametrical.

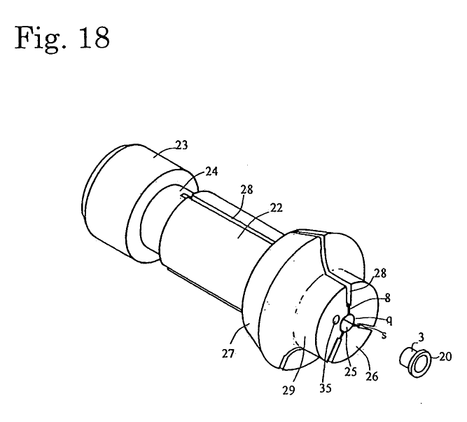

FIG. 18 is a perspective view showing the resistance welding-use electrode in Example 2 in a free state and the cap. In Example 2 also, the gaps 8 exist in a free state. The inner circumferential length L of the hole 25 is the sum of the three gaps, 3s, and the three inner arc lengths, 3q, of the three segments of the foot portion 7; that is, L=3s+3q.

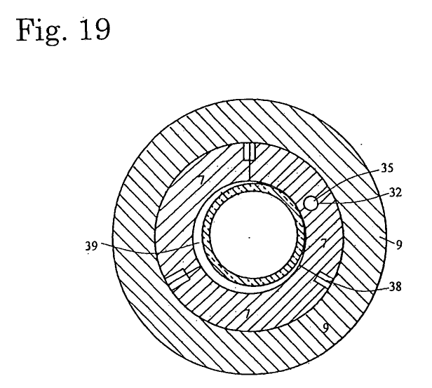

When the foot portion 7 holds the cap and is pressed inward with a clamping member, the gaps 8 disappear completely. FIG. 19 is a cross-sectional view showing a state in which the cap is held. The neighboring segments of the foot portion 7 are brought into tight contact. The inner circumferential length of the hole 25 becomes M=3q. At this moment, this structure is designed such that a gap 39 remains between the cap 3 as the object and the wall of the hole 25. More specifically, when the outer circumferential length of the cap is denoted as K, then M=3q>K. In the conventional example, the relationship is L>K>M. On the other hand, in the present invention, the relationship is changed to L>M>K.

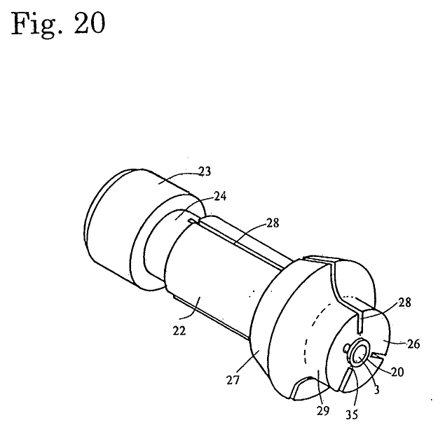

FIG. 20 is a perspective view showing a state in which the cap is held by the resistance welding-use electrode in Example 2. For easy understanding, the clamping member is omitted from FIG. 20. The end face 26 has no gap at an area lying over the flange 20. It becomes a unified flat face. This is the same as shown in FIG. 11 for Example 1. The state in which the cap 3 is held by the resistance welding-use electrode 4 and the cap 3 is combined with the stem 2 is nearly the same as that shown in FIGS. 12 and 13 for Example 1.

When the foot portion of the resistance welding-use electrode is closed, the gaps 8 are closed and disappear. Because the gap between the individual segments of the foot portion 7 has disappeared, the end face 26 has no groove at an area lying over the flange 20 and it becomes a flat face.

At a portion lying over the flange 20, a clamping member 9 unifies circumferentially the foot portion 7 divided into three segments. A gap 39 exists between the cap 3 and the wall of the hole 25. The cap 3 is held not by mechanical stress but by magnetic force of the permanent magnet 32. The cap 3 is made of a material that can be attracted by a magnet, such as iron, cobalt, or nickel.

When the resistance welding-use electrode and the cap are lowered to put on top of the stem 2, a state shown in FIG. 13 is produced, which is the same state as that in Example 1. The bottom flange 20 of the cap 3 is brought into contact with the upper face of the stem 2. The foot portion 7 of the resistance welding-use electrode 4 presses the flange 20 intensely. The three segments of the foot portion 7 are brought into tight contact with one another at the boundary lines 38. Consequently, the lower portion of the resistance welding-use electrode 4 at a portion lying over the flange 20 is circumferentially unified. The unified foot portion 7 presses the flange 20 onto the stem 2.

Because the foot portion 7 has no gaps at a portion lying over the flange 20, when an electric current is injected into the resistance welding-use electrode vertically, the current flows uniformly over the entire circumference of the flange. No gap exists circumferentially at all. When a heavy current is fed across the resistance welding-use electrode and the stage, the current flows vertically with maintaining a uniform current density circumferentially in the flange.

Because the current density is uniform circumferentially, the heating becomes uniform circumferentially. The state of the welding also becomes uniform circumferentially. The welding has no possibility of producing unevenness. The conventional electrode secures the positional precision by clamping. However, the conventional method produces gaps, so that the useful life of the electrode is shortened. In the present invention, the diameter of the hole is increased, so that the positional precision has some variations. Nevertheless, the holding of the cap with a magnet uniquely determines the position of the cap in the hole of the electrode. As a result, a positional precision comparable to that by the clamping can be secured.

The cap is held by magnetic force of the permanent magnet. Consequently, a force is not applied to the outer periphery of the cap. Because the cap is free from stress, it has no possibility of deforming, distorting, or the like. Because the resistance welding-use electrode also does not undergo an external force, it does not deform or wear. The useful life of the electrode is prolonged. The conventional electrode has a useful life of no more than 1,000 shots or so even when used by repeated polishing. On the other hand, the electrode in Example 2 of the present invention has a useful life of 3,000 shots or more.

What is claimed is:

1. A resistance welding-use electrode, comprising:
(a) a foot portion that:
(a1) is divided into a plurality of segments by a gap; and
(a2) is provided, at the end face, with a hole into which an object to be welded is to be inserted; and
(b) a permanent magnet provided at the end portion of the foot portion;
the resistance welding-use electrode having a structure in which the object is held by magnetic force of the permanent magnet under the condition that:
(c) the foot portion is pressed inward, so that the segments are brought into contact with one another without a gap; and
(d) a gap is produced between the object and the wall of the hole.

2. A resistance welding-use electrode as defined by claim 1, wherein:
(a) the foot portion is further provided with a magnet-housing hole bored axially at the end portion of the foot portion; and
(b) the permanent magnet is housed in the magnet-housing hole.

3. A resistance welding-use electrode as defined by claim 1, wherein:
(a) the foot portion is further provided with a magnet-housing hole bored radially at the end portion of foot portion; and
(b) the permanent magnet is housed in the magnet-housing hole.

4. A resistance welding-use electrode as defined by claim 1, wherein:
(a) the number of segments is three; and
(b) under the condition that the foot portion is pressed inward so that the three segments are brought into contact with one another without a gap, the sum of the inner arc lengths of the three segments, M=3q, is greater than the outer circumferential length of the object, K, (M>K), where “q” indicates the inner arc length of each of the three segments.
